(19) United States
(12) Patent Application Publication
(10) Pub. No.: US 2010/0091756 A1
(43) Pub. Date: Apr. 15, 2010

(54) METHOD OF USING ACKNOWLEDGMENT TONES FOR DATA CONSISTENCY IN INTRA-VEHICULAR WIRELESS NETWORKS

(75) Inventors: Thomas Alfons Hogenmueller, Sunnyvale, CA (US); Vivek Jain, Mountain View, CA (US); Lakshmi Venkatraman, Palo Alto, CA (US); Abtin Keshavarzian, Palo Alto, CA (US); Krishna Chintalapudi, Sunnyvale, CA (US); Serbulent Tozlu, Sunnyvale, CA (US); Yuan Tian, Mountain View, CA (US)

Correspondence Address: TAFT STETTINIUS & HOLLISTER LLP, ONE INDIANA SQUARE, SUITE 3500, INDIANAPOLIS, IN, 46204, US

(73) Assignee: Robert Bosch GmbH, Stuttgart (DE)

(21) Appl. No.: 12/248,311

(22) Filed: Oct. 9, 2008

(51) Int. Cl. H04J 3/00; H04B 7/00

(52) U.S. Cl. 370/345; 370/310

(57) ABSTRACT

A method for providing electronic communications between wireless nodes includes wirelessly transmitting data from a transmitting one of the nodes to a plurality of receiving ones of the nodes. A respective first acknowledgment tone is wirelessly transmitted from each of the receiving nodes to the transmitting node and to each other one of the receiving nodes. Each first acknowledgment tone is transmitted in response to the respective receiving node receiving the transmitted data. Each of the first acknowledgment tones is transmitted in a respective, unique time slot. At least one second acknowledgment tone is wirelessly transmitted from at least one of the nodes to each other one of the nodes. The second acknowledgment tone is transmitted dependent upon whether a group of received first acknowledgment tones matches a group of expected-to-be-received first acknowledgment tones.

### BACKGROUND

1. Field of the Invention

The present invention relates to a method for wireless communication, and, more particularly, to a method for wireless communication with increased performance and reliability within a vehicle.

2. Description of the Related Art

It is known for wireless communication to be employed between and within various systems within a vehicle, such as an automobile. Attaining reliable wireless communication with good performance is problematic within a vehicle, however, because wireless communication is deeply affected by fading due to multipath, and human and metallic obstructions inside the vehicle. Hence, in many wireless applications, particularly intra-vehicular wireless networks, to ensure reliability and data consistency, it is required to receive acknowledgement from all intended receiver nodes for a broadcast/multicast packet.

Conventional methods of providing acknowledgements include transmitting acknowledgment/negative acknowledgement (ACK/NACK) packets or using ACK tones to increase reliability. However, using ACK/NACK packets or tones has its own pros and cons. Packets increase the reliability but can also increase the network delay as they are prone to getting lost or corrupt due to channel fading. Tones, on the other hand, consume less time and are immune to channel fading which can compromise their authenticity. However, the level of data inconsistency associated with tones has not been explored because most of broadcast/multicast packets do not require acknowledgement in usual wireless networks.

In contrast to wired networks, in wireless networks the acknowledgment of broadcasted messages by the receiving nodes is a time consuming process as each receiver node needs to send a separate acknowledgment (ACK) packet. A packet normally includes a preamble phase, sending station ID, destination station ID, data bits or status bits and a checksum. Thus, in case a broadcasted message needs to be acknowledged by many receiving nodes, the positive acknowledgment process becomes time consuming.

Another strategy is to use negative acknowledgments wherein a node sends a negative acknowledgment (NACK) when it does not receive an expected packet or it receives an erroneous packet. However, this scheme does not guarantee that all other receiving nodes receive the broadcasted packet. For example, the receiving node may be dead and hence unable to transmit a negative acknowledgment packet. This leads to data inconsistency in networks as some nodes receive a message and some do not. Further, the worst case complexity in terms of total ACK or NACK messages transmitted is the same for positive or negative acknowledgement schemes. Another problem is the possibility of ACK or NACK packets being lost due to faulty wireless channels, which may lead to further delays.

What is needed in the art is a method for acknowledging packet delivery in a wireless network communication system that avoids the above-mentioned problems and disadvantages.

### SUMMARY OF THE INVENTION

The present invention provides methods and mechanisms to provide data consistency, ensure reliability of data delivery, and reduce delays in wireless network communication systems.

In one embodiment, the present invention provides tones on designated frequency channels in an efficient way to indicate acknowledgments. If all of the acknowledgment tones associated with the previous data packet are not properly received, then the nodes that did receive the previous data packet may nevertheless delete the data packet and wait for the data packet to subsequently be re-transmitted. Thus, either all receiver nodes have the same copy of data or all receiver nodes have no data, thereby ensuring that all receiver nodes have the same, consistent data. Dependent upon receipt of the acknowledgment tones from the receiver nodes, the transmitter node also knows whether its intended receivers have consistent data or not. If not, then an error handling technique such as re-transmission of the designated data packet may be undertaken.

In another embodiment, the present invention provides a method for enabling a transmitting node to utilize negative acknowledgment tones. In a negative acknowledgment scheme, the transmitting node takes no action if it properly receives acknowledgment tones from all receiver nodes, and the transmitting nodes transmits a negative acknowledgment tone if it does not properly receive the acknowledgment tones from all receiver nodes. Negative acknowledgments may be used in identifying faulty receivers and/or channels. Multiple transmitters may transmit a data packet simultaneously and on the same channel. If a receiving node does not receive any of the data packets, and thus does not acknowledge receipt, then the transmitting node may assume that the receiving node and/or channel is faulty. The transmitting node may indicate that the receiving node and/or channel is faulty in the negative acknowledgment tone that the transmitting node transmits.

In yet another embodiment, the present invention provides a method for using tone signatures to reduce false detection of acknowledgments that may occur due to surrounding noise. Tone signatures involve each node sending multiple acknowledgment tones in a combination of pre-determined frequency channels and time slots that is unique to each transmitting node.

The invention comprises, in one form thereof, a method for providing electronic communications between wireless nodes, including wirelessly transmitting data from a transmitting one of the nodes to a plurality of receiving ones of the nodes. A respective first acknowledgment tone is wirelessly transmitted from each of the receiving nodes to the transmitting node and to each other one of the receiving nodes. Each first acknowledgment tone is transmitted in response to the respective receiving node receiving the transmitted data. Each of the first acknowledgment tones is transmitted in a respective, unique time slot. At least one second acknowledgment tone is wirelessly transmitted from at least one of the nodes to each other one of the nodes. The second acknowledgment tone is transmitted dependent upon whether a group of received first acknowledgment tones matches a group of expected-to-be-received first acknowledgment tones.

The invention comprises, in another form thereof, a method for providing electronic communications between wireless nodes, including wirelessly transmitting a plurality of data packets. Each of the data packets is transmitted from a corresponding one of the nodes to other ones of the nodes. A respective first acknowledgment tone is wirelessly transmitted from each of the nodes receiving the data packets. Each first acknowledgment tone corresponds to receipt of a respective data packet. Each first acknowledgment tone is transmitted to each other one of the nodes. Each first acknowledgment tone is transmitted simultaneously with transmission of a corresponding one of the data packets that is subsequent to the data packet whose receipt corresponds to the first acknowledgment tone. At least one second acknowledgment tone is selectively wirelessly transmitted from at least one of the nodes. The transmitting of the second acknowledgment tone depends upon receipt of all expected ones of the first acknowledgment tones.

The invention comprises, in yet another form thereof, a method for providing electronic communications between wireless nodes, including wirelessly transmitting data from a transmitting one of the nodes to a plurality of receiving ones of the nodes. A respective set of first acknowledgment tones is wirelessly transmitted from each of the receiving nodes to the transmitting node and to each other one of the receiving nodes. Each set of first acknowledgment tones is transmitted in response to the respective receiving node receiving the transmitted data. At least one set of second acknowledgment tones is wirelessly transmitted from at least one of the nodes to each other one of the nodes. Each set of second acknowledgment tones is transmitted dependent upon whether a group of received first acknowledgment tones matches a group of expected-to-be-received first acknowledgment tones. Each one of the sets of first acknowledgment tones and each one of the sets of second acknowledgment tones is transmitted in a corresponding sequence of frequency channels that is unique to the node transmitting the set of acknowledgment tones.

An advantage of the present invention is that the acknowledgment tones of the present invention increase the reliability and data consistency of wireless communications while at the same time consuming less time than do acknowledgment packets, and being immune to channel fading.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagram of one embodiment of a wireless automotive network of the present invention.

FIG. 2a is a frequency domain plot of a frequency channel used for data transmissions according to one embodiment of the present invention.

FIG. 2b is a frequency domain plot of a frequency channel used for acknowledgment tones according to the embodiment of FIG. 2a.

FIG. 2c is a frequency domain plot of separate frequency channels used for data transmissions and acknowledgment tones according to another embodiment of the present invention.

FIG. 3a is a simplified time domain plot of acknowledgment tones according to one embodiment of the present invention.

FIG. 3b is a more detailed time domain plot of the acknowledgment tones of FIG. 3a.

FIG. 3c is a simplified time domain plot of acknowledgment tones according to another embodiment of the present invention.

FIG. 3d is a more detailed time domain plot of the acknowledgment tones of FIG. 3c.

FIG. 4 is a time domain plot of a sequential data acknowledgment scheme according to one embodiment of the present invention.

FIG. 5a is a time domain plot of data transmissions according to a sequential data acknowledgment scheme with pipelining according to another embodiment of the present invention.

FIG. 5b is a time domain plot of acknowledgment tones corresponding to the data transmissions of FIG. 5a according to the sequential data acknowledgment scheme with pipelining depicted in FIG. 5a.

FIG. 6 is a time domain plot of another embodiment of a sequential data acknowledgment scheme according to the present invention.

FIG. 7a is a time domain plot of a sequential data acknowledgment scheme with negative acknowledgments according to a further embodiment of the present invention.

FIG. 7b is a more detailed time domain plot of a portion of the sequential data acknowledgment scheme with negative acknowledgments depicted in FIG. 7a.

FIG. 8a is a time domain plot of a sequential data acknowledgment scheme according to yet another embodiment of the present invention.

FIG. 8b is a more detailed time domain plot of a portion of the sequential data acknowledgment scheme depicted in FIG. 8a.

FIG. 8c is a still more detailed time domain plot of several portions of the sequential data acknowledgment scheme depicted in FIG. 8b.

FIG. 9a is a time domain plot of a sequential data acknowledgment scheme according to a further embodiment of the present invention.

FIG. 9b is a more detailed time domain plot of a portion of the sequential data acknowledgment scheme depicted in FIG. 9a.

FIG. 9c is a still more detailed time domain plot of several portions of the sequential data acknowledgment scheme depicted in FIG. 9b.

FIG. 10 is a flow chart illustrating one embodiment of a method of the present invention for providing electronic communications between wireless nodes.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

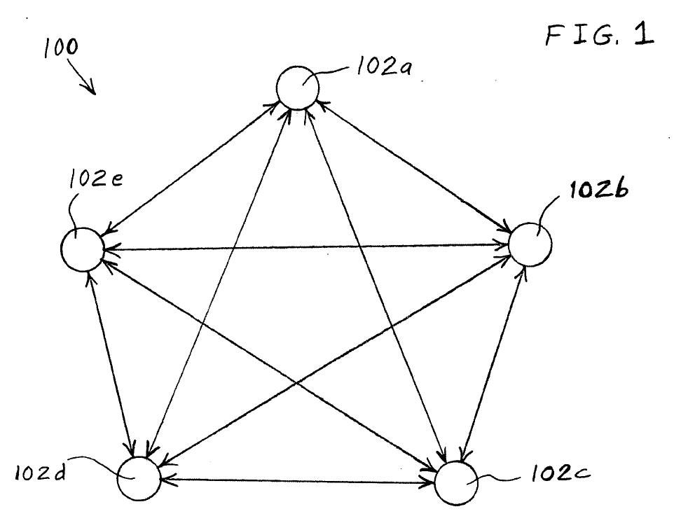

Referring now to FIG. 1, there is shown one embodiment of a wireless network 100 of the present invention including wireless nodes 102a-e. As depicted by the double arrows in FIG. 1, each of wireless nodes 102a-e may be in bi-directional wireless communication with each of the other wireless nodes in network 100. The method of the present invention may avoid data inconsistency and reduce delays in the wireless communication between nodes 102 by using tones on designated frequency channels in an efficient way to indicate acknowledgments. An acknowledgment may be indicated by a single frequency tone rather data by a data packet, thereby reducing the length of time required to achieve an acknowledgment. A tone may be in the form of a pulse having a single frequency and a relatively short time duration.

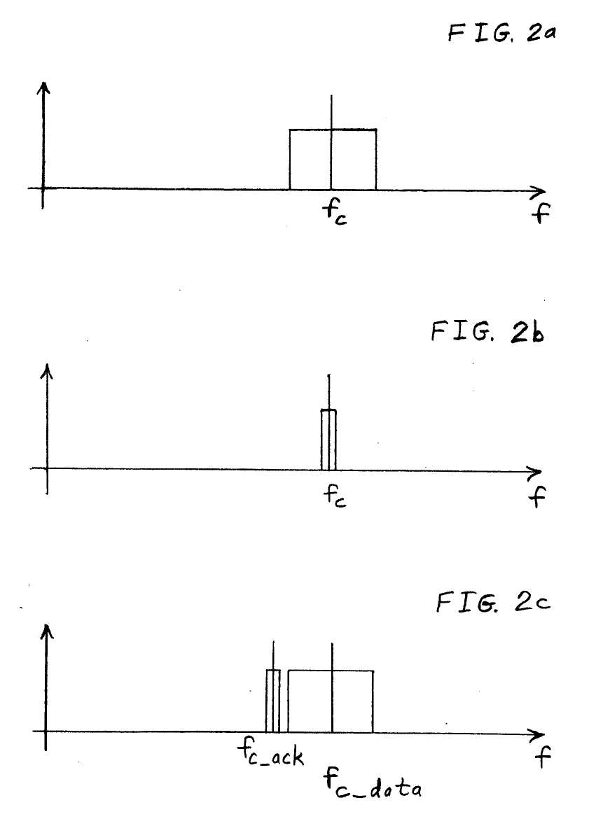

There are two possible ways of realizing tone based acknowledgments. In a first way, illustrated in FIGS. 2a-b, the same carrier frequency is used for data transmission and the acknowledgment tones. This may be referred to as an “in-band acknowledgment tones.” FIG. 2a illustrates the data transmission being centered on frequency channel f_{c}. As shown in FIG. 2b, the associated acknowledgment tone may also be centered on frequency channel f_{c}, but may have a narrower bandwidth than does the data transmission of FIG. 2a. The channel width may vary depending upon the hardware used. However, the acknowledgment tones may be unmodulated carriers.

FIG. 2c illustrates a second possible way of realizing tone based acknowledgments, which may be referred to as “out-of-band acknowledgment tones.” In this scheme, separate frequency channels are used for transmission of data and acknowledgment tones. The lower frequency channel may be used for the acknowledgment tone of each wireless node, and the higher frequency channel may be used for data transmission.

In the methods for improving data consistency in multicast and broadcast communications described below, an underlying assumption is that tones are never lost, which is a practical, real life assumption. If two nodes exchange tones under normal circumstances, they continue to do so unless one is dead or an external physical interference is introduced. Tones are not affected by any other wireless communication. However, any wireless communication in the same band can result in false tones. Such false tones may be avoided by use of tone signatures, as described below.

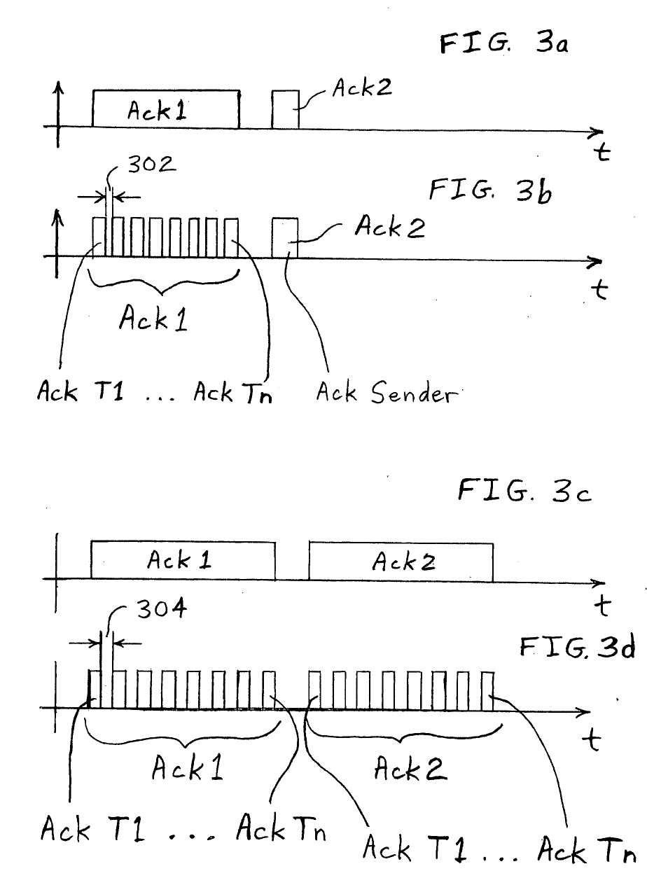

In the acknowledgment methods of the present invention, each data transmission, which may be in the form of transmitted data packets, may be followed by two acknowledgment windows. Examples of such acknowledgment windows are labeled “Ack1” and “Ack2” in FIGS. 3a and 3c. In the Ack1 window, all nodes in the system send out their acknowledgment tones Ack T1, Ack T2, . . . , Ack Tn, wherein “n” is the number of receiver nodes. The acknowledgment tones may be sent out in a predefined order in order to acknowledge a successful reception of the data packet.

The Ack1 window is shown in the same form in FIGS. 3a and 3c. In contrast, however, the Ack2 window is shown in different forms in FIGS. 3a and 3c. That is, the Ack2 window may be realized in two different ways illustrated in FIGS. 3a and 3c, respectively. FIG. 3a illustrates the scenario of a transmitter-Ack, i.e., an acknowledgment produced by a transmitter node. Conversely, FIG. 3c illustrates the scenario of a receivers-Ack, i.e., an acknowledgment produced by receiver nodes. In the transmitter-Ack case, if the sender node receives acknowledgment tones from all the intended receiver nodes in the previous Ack window, then the sender node sends an acknowledgment tone in the Ack2 window denoting successful receptions of packets by all nodes. Otherwise, if the sender node does not receive acknowledgment tones from all the intended receiver nodes in the previous Ack window, then the sender node sends nothing. As a next step, an error handling procedure such as retransmission of the designated data packet can be established.

In the receivers-Ack case, during the Ack1 window, all receiving nodes also sense the channel and wait for the tone from each receiver node in the system. Then, in the Ack2 window as illustrated in detail in FIG. 3d, each receiver node may acknowledge that it received the acknowledgment tones from all other nodes in the Ack1 window. This may be realized again in the predefined order as described above. In the case that a node does not receive an acknowledgment tone from each of the other nodes in the previous Ack1 window, then the node does not send out an acknowledgement tone in the second acknowledgment window Ack2. Thus, if the transmitting node does not receive an acknowledgment tone from all other nodes in the Ack2 window, then the transmitting node may assume that that packet was not received by all other receiving nodes. Therefore, the transmitting mode may then retransmit the data packet or may execute any other error resolution procedure. Meanwhile, all receiving nodes know that the current data packet is inconsistent with respect to other receiver nodes. Thus, all nodes that correctly received the data packet that was not correctly received by all other nodes will drop, i.e., delete, this data packet.

Regardless of whether the transmitter-Ack case or the receivers-Ack case is used, each acknowledgement tone in the Ack2 window may be transmitted if, and only if, the node that is to transmit the acknowledgement tone in the Ack2 window receives all of the acknowledgement tones in the Ack1 window that it expects to receive. Thus, all of the nodes may have knowledge of each other node in the network.

The transmitter-Ack scheme of FIGS. 3a-b may be faster than the receivers-Ack scheme of FIGS. 3c-d. Not only is just a single acknowledgment tone transmitted in the Ack2 window in the transmitter-Ack scheme, but also the transmitter-Ack scheme eliminates the need for nodes to sense ACK tones of other nodes in the Ack1 window. Thus, the inter-tone time spacing may be reduced in the transmitter-Ack scheme as compared to the receivers-Ack scheme as the switching time may be shortened. That is, the inter-tone time spacing 302 (FIG. 3b) in the transmitter-Ack scheme may be shorter than the inter-tone time spacing 304 (FIG. 3d) in the receivers-Ack scheme. The receivers-Ack scheme, however, may have the advantage of being more robust as the onus of decision-making is on several nodes rather than on just one, and thus the probability of false alarms may be reduced.

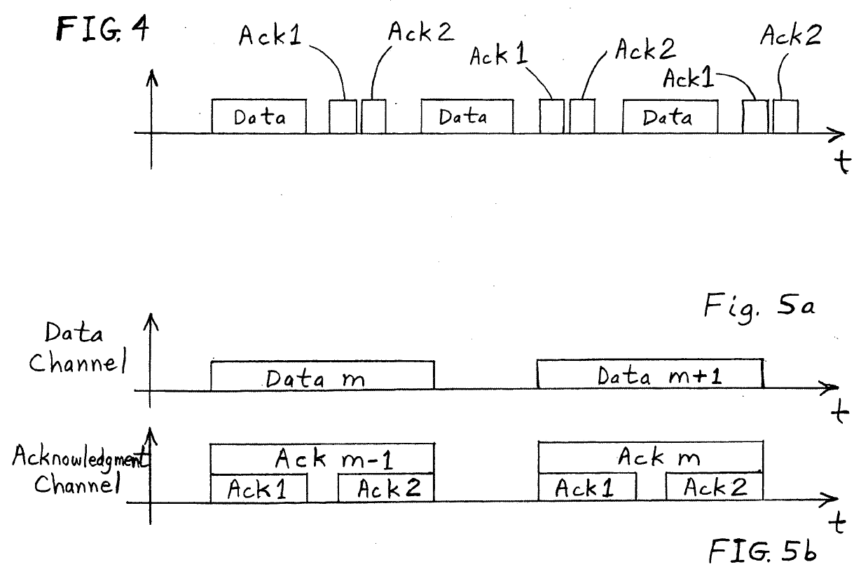

In one particular embodiment of the application of the Ack1 and Ack2 acknowledgment windows described above, each data transmission may be followed by the two acknowledgment windows Ack1 and Ack2 in sequential order, as illustrated in FIG. 4. In this embodiment, sequential data-acknowledgment may be realized using both in-band and out-of-band acknowledgment tones. That is, acknowledgment tones Ack1 and Ack2 may or may not be transmitted at the same frequency as the carrier frequency of the data transmissions.

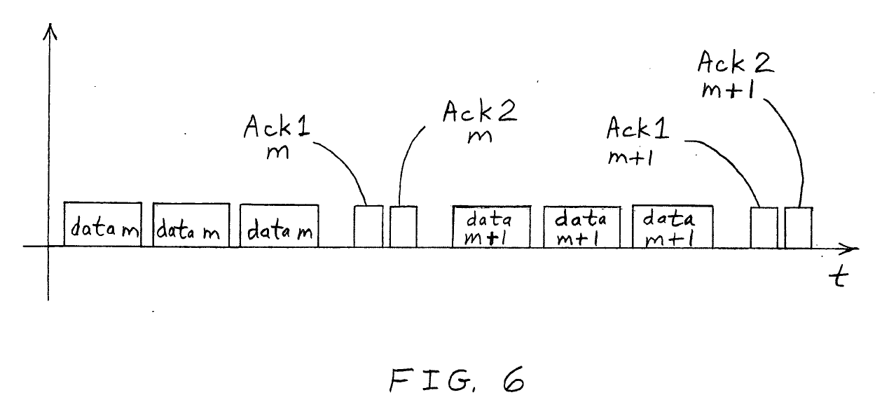

FIGS. 5a and 5b illustrate an embodiment in which acknowledgment tones Ack1 and Ack2 are not transmitted at the same frequency as the carrier frequency of the data transmissions. In this sequential data-acknowledgment with pipelining scheme, by using out-of-band acknowledgment tones it is possible to send/sense acknowledgment tones and receive data packets at the same point in time. In one embodiment, two radios are utilized. The primary radio may be used for receiving data packets, while the secondary radio is used to send/sense acknowledgment tones for the data packet that immediately preceded the data packet currently being received by the primary radio. That is, while the primary radio is receiving an m^{th} data packet on the data frequency channel (FIG. 5a), the secondary radio may be sending and/or sensing acknowledgment tones for a (m−1)^{th} data packet on the acknowledgment frequency channel. Stated differently, the first and second acknowledgment tones may be transmitted simultaneously with transmission of a corresponding one of the data packets that is subsequent to the data packet whose receipt corresponds to the first acknowledgment tone.

In the embodiment of FIGS. 5a and 5b, the overall communication schedule may be modified to provide retransmission or error resolution procedures depending upon the application requirements. For example, while transmitting the m^{th} data packet, if the transmitting nodes do not receive all expected acknowledgment tones for the (m−1)^{th} data packet, then in the next subsequent slot (in which the (m+1)^{th} data packet would otherwise be transmitted) the transmitter node may re-transmit the (m−1)^{th} data packet while the receiver nodes transmit the acknowledgments for the m^{th} data packet.

The sequential data-acknowledgment scheme may be further extended to enhance reliability whereby instead of transmitting each data packet only once, multiple copies of the same data packet are transmitted followed by the acknowledgment windows as illustrated in FIG. 6. The number of copies that are consecutively transmitted may be computed based upon an expected channel error rate.

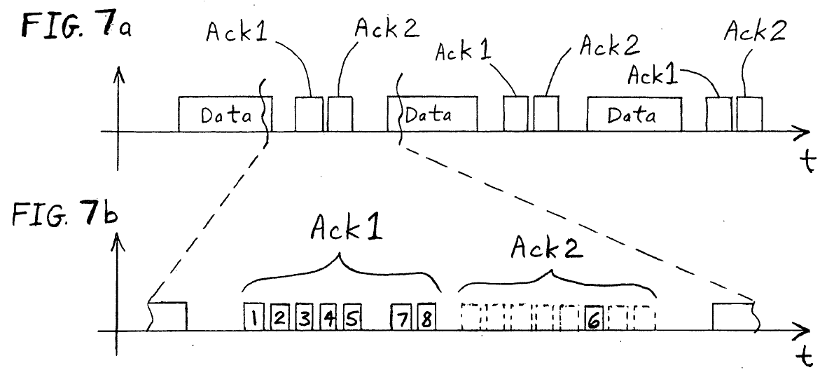

Illustrated in FIGS. 7a and 7b is another embodiment in which negative acknowledgments may be used to identify a faulty receiver node in a receivers-Ack scheme. Negative acknowledgment is another approach of acknowledging the reception of acknowledgment tones from the other receiver nodes. In this scheme, if a node receives acknowledgment tones from all other receiver nodes in the Ack1 window, then the node does not transmit any tone in the Ack2 window. However, if not all acknowledgment tones are received by the node in the Ack1 window, then, in the Ack2 window, it sends a tone in the time slot of the node(s) from which it did not receive the acknowledgment tone. Thus, a negative acknowledgment tone may be transmitted in response to less than all of the expected first acknowledgment tones being received. This is negative acknowledgment receiver-Ack scheme is illustrated in FIGS. 7a and 7b. FIG. 7a illustrates the overall scheme in which each data transmission is followed by an Ack1 window and an Ack2 window.

FIG. 7b illustrates the details of one exemplary acknowledgment scenario in which a receiving node associated with the sixth time slot fails to transmit an acknowledgment tone in the Ack1 window. The transmitting node receives the acknowledgment tones in the first through fifth and seventh and eighth time slots, but does not receive any acknowledgment tone in the sixth time slot. Thus, the transmitting node has some evidence that the receiving node associated with the sixth time slot is faulty, but has no confirmation of such as of the end of the Ack1 window. Thus, it is possible that the receiving node associated with the sixth time slot is indeed sending its acknowledgment tone in the sixth time slot of the Ack1 window, but the transmitting node is not receiving the acknowledgment tone due to some interference. In order to provide the transmitter node with confirmation that no acknowledgment tone was transmitted in the sixth time slot of the Ack1 window, each of the other receiving nodes (besides the faulty receiving node) transmits a negative acknowledgment tone in the sixth time slot of the Ack2 window. If two or more nodes transmit tones in the same time slot, then for other nodes the two or more tones appears as a single tone. No tones are transmitted in time slots one through five and seven and eight in the Ack2 window, as indicated by dashed lines in FIG. 7b. The transmitting node receives the negative acknowledgment tone in the sixth time slot of the Ack2 window, and thus the transmitting node has it confirmed by the other receiving nodes that the receiving node associated with the sixth time slot of the Ack1 window is faulty, or at least is not transmitting acknowledgment tones. Thus, in this way, the transmitting node can identify bad receivers and can execute error correction procedures accordingly.

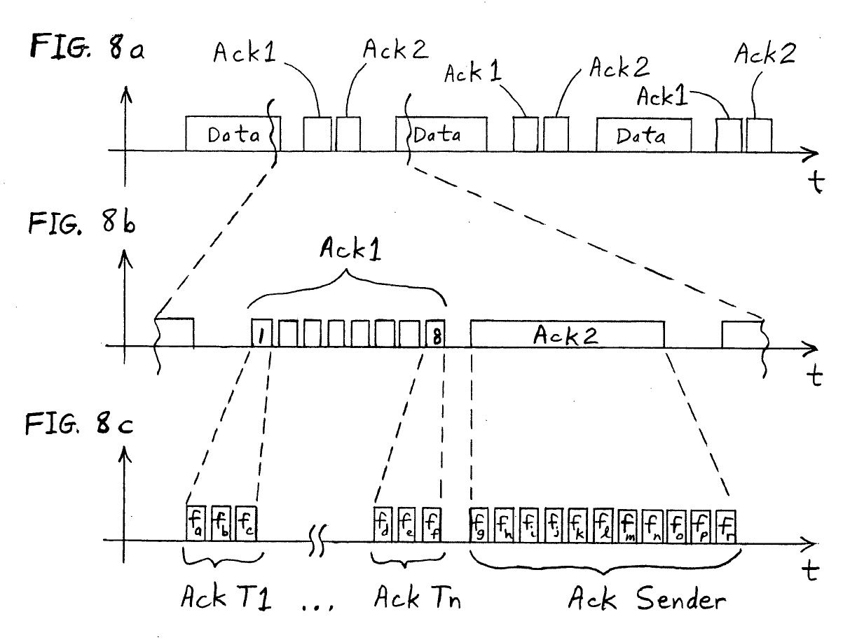

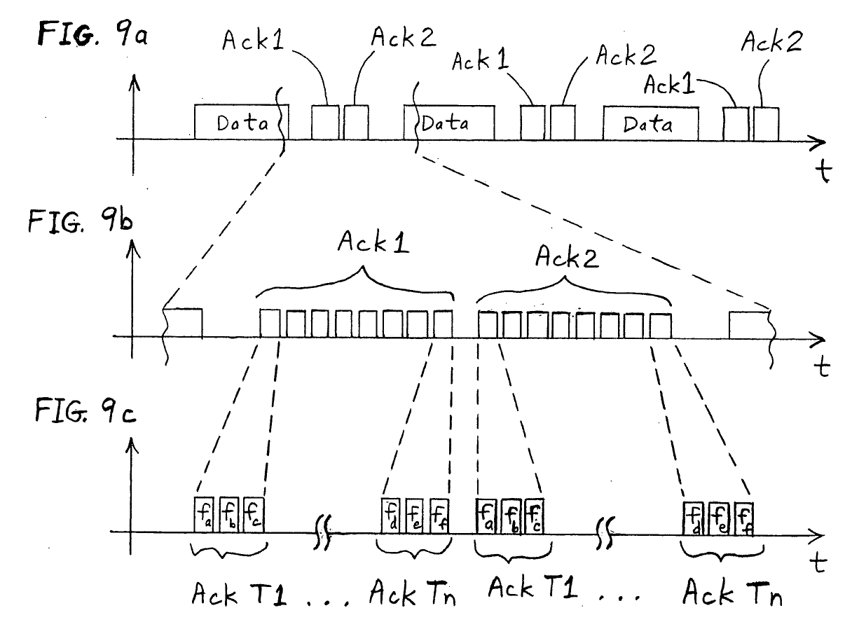

As mentioned briefly above, nodes may mistakenly interpret noise surrounding the expected frequency of an acknowledgment tone as an actual acknowledgment tone. This phenomenon is termed a “false alarm.” To address this issue, in one embodiment of the present invention, each node transmits multiple acknowledgment tones in predetermined respective frequency channels and predetermined time slots. Each node is assigned multiple predetermined time slots and associated predetermined frequencies in which the node may either transmit respective tones or not send any tone. Such a pattern of acknowledgment tones from a node in specific and/or predetermined combinations of time slots and frequencies characterizes “tones signatures” which are distinct and unique for each node. As is evident from the specific tones signature embodiments in FIGS. 8a-c and 9a-c, the use of tones signatures may reduce the probability of false alarms because the probability of there being noise in all frequency channels is lower than the probability of there being noise in one frequency channel.

In the transmitter-Ack scheme illustrated in FIGS. 8a-c, each receiving node has a tones signature including a set of three consecutive tones at respective frequencies and within respective time slots. More particularly, in the Ack1 window, the receiving node assigned to the first of the eight time slots in the Ack1 window transmits three consecutive tones in a sequence of frequencies fₐ, f_{b} and f_{c}, respectively. The receiving node assigned to the eighth of the eight time slots in the Ack1 window transmits three consecutive tones having frequencies of f_{d}, fₑ and f_{f}, respectively. In the Ack2 window, the transmitting node transmits a series of eleven consecutive tones having respective sequential frequencies f_{g-r}. In one embodiment, the first three of these tones, having frequencies f_{g}, fₕ and fᵢ, respectively, may form the tones signature of the transmitting node. The remaining and subsequent eight tones may each be an acknowledgment that a respective one of the eight acknowledgment tones in the Ack1 window was received by the transmitting node. In one embodiment, because these final eight tones are not part of the transmitting node's tones signature, their respective frequencies fⱼ₋ᵣ may all be the same frequency.

In the receivers-Ack scheme illustrated in FIGS. 9a-c, the tones signatures for the receiving nodes are the same in the Ack1 window as in the Ack2 window. That is, the receiver node associated with the first time slot has a times signature including three consecutive nodes having frequencies fₐ, f_{b} and f_{c}, respectively. The receiving node assigned to the eighth of the eight time slots has a times signature including three consecutive tones having frequencies f_{d}, fₑ and f_{f}, respectively. Each one of the sets of acknowledgment tones in the Ack1 window and each one of the sets of acknowledgment tones in the Ack2 window may be transmitted in a corresponding sequence of frequency channels that is unique to the node transmitting the set of acknowledgment tones.

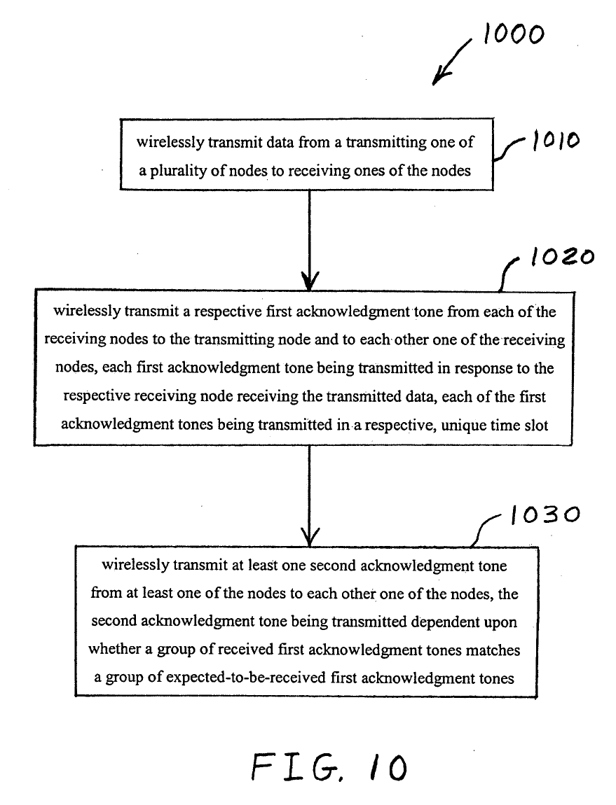

FIG. 10 is a flow chart illustrating one embodiment of a method 1000 of the present invention for providing electronic communications between wireless nodes. In a first step 1010, data is wirelessly transmitted from a transmitting one of the nodes to a plurality of receiving ones of the nodes. For example, one of nodes 102 (FIG. 1) may wirelessly transmit data that is intended for, and that is received by, each of the other nodes 102.

In a next step 1020, a respective first acknowledgment tone is wirelessly transmitted from each of the receiving nodes to the transmitting node and to each other one of the receiving nodes, each first acknowledgment tone being transmitted in response to the respective receiving node receiving the transmitted data, each of the first acknowledgment tones being transmitted in a respective, unique time slot. As a specific example, FIG. 3b illustrates first acknowledgment tones Ack T1 through Ack Tn which are wirelessly transmitted from respective receiving nodes 1 through n. These first acknowledgment tones are transmitted to the transmitting node as well as to each of the other receiving nodes. Each receiving node transmits its respective first acknowledgment tone in response to receiving the data from the transmitting node. As also can be seen in FIG. 3b, each of first acknowledgment tones Ack T1 through Ack Tn is transmitted in its own separate time slot so that no two first acknowledgment tones are transmitted at the same time.

Next, in final step 1030, at least one second acknowledgment tone is wirelessly transmitted from at least one of the nodes to each other one of the nodes, the second acknowledgment tone being transmitted dependent upon whether a group of received first acknowledgment tones matches a group of expected-to-be-received first acknowledgment tones. For example, in FIG. 3b, second acknowledgment tone Ack Sender is wirelessly transmitted from the transmitting node to each of the receiving nodes. Second acknowledgment tone Ack Sender may be transmitted if, and only if, the transmitting node receives all of the first acknowledgment tones that it expects to receive, such as at least one first acknowledgment tone from each of the receiving nodes. In another example which is illustrated in FIG. 3d, second acknowledgment tones Ack T1 through Ack Tn are wirelessly transmitted from respective receiving nodes to the transmitting node as well as to each other one of the receiving nodes. Each individual second acknowledgment tone Ack T1 through Ack Tn may be transmitted if, and only if, the respective receiving node receives all of the first acknowledgment tones that it expects to receive, such as at least one first acknowledgment tone from each of the other receiving nodes.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for providing electronic communications between wireless nodes, the method comprising the steps of:
wirelessly transmitting data from a transmitting one of the nodes to a plurality of receiving ones of the nodes;
wirelessly transmitting a respective first acknowledgment tone from each of the receiving nodes to the transmitting node and to each other one of the receiving nodes, each said first acknowledgment tone being transmitted in response to the respective receiving node receiving the transmitted data, each of the first acknowledgment tones being transmitted in a respective, unique time slot; and
wirelessly transmitting at least one second acknowledgment tone from at least one of the nodes to each other one of the nodes, the second acknowledgment tone being transmitted dependent upon whether a group of received said first acknowledgment tones matches a group of expected-to-be-received said first acknowledgment tones.

2. The method of claim 1 wherein the second acknowledgment tone is transmitted by the transmitting node, the second acknowledgment tone being transmitted in response to the transmitting node receiving each of the expected-to-be-received first acknowledgment tones.

3. The method of claim 1 wherein the at least one second acknowledgment tone comprises a plurality of second acknowledgment tones, each said second acknowledgment tone being transmitted by a respective one of the receiving nodes, each said second acknowledgment tone being transmitted in response to the respective receiving node receiving each of the expected-to-be-received first acknowledgment tones.

4. The method of claim 1 wherein the at least one second acknowledgment tone comprises a plurality of negative acknowledgment tones, each said negative acknowledgment tone being transmitted by a respective one of the receiving nodes, each said negative acknowledgment tone being transmitted in response to the first acknowledgment tones received by the respective receiving node not matching the expected-to-be-received group of first acknowledgment tones.

5. The method of claim 4 wherein each of the negative acknowledgment tones is transmitted in a same time slot, the same time slot corresponding to and uniquely identifying one of the receiving nodes from which an expected-to-be-received said first acknowledgment tone was not received.

6. The method of claim 1 wherein the step of wirelessly transmitting data comprises wirelessly transmitting multiple copies of the data, each said first acknowledgment tone being transmitted in response to the respective receiving node receiving at least one of the copies of the transmitted data.

7. The method of claim 1 wherein a frequency channel of the acknowledgment tones is outside a frequency channel of the data.

8. A method for providing electronic communications between wireless nodes, the method comprising the steps of:
wirelessly transmitting a plurality of data packets, each of the data packets being transmitted from a corresponding one of the nodes to other ones of the nodes;
wirelessly transmitting a respective first acknowledgment tone from each of the nodes receiving the data packets, each said first acknowledgment tone corresponding to receipt of a respective said data packet, each said first acknowledgment tone being transmitted to each other one of the nodes, each first acknowledgment tone being transmitted simultaneously with transmission of a corresponding one of the data packets that is subsequent to the data packet whose receipt corresponds to the first acknowledgment tone; and
selectively wirelessly transmitting at least one second acknowledgment tone from at least one of the nodes, the transmitting of the second acknowledgment tone depending upon receipt of all expected ones of the first acknowledgment tones.

9. The method of claim 8 wherein the at least one second acknowledgment tone comprises a plurality of second acknowledgment tones, each said second acknowledgment tone corresponding to at least one of the first acknowledgment tones, each said second acknowledgment tone being transmitted simultaneously with transmission of the respective subsequent data packet.

10. The method of claim 8 wherein a transmitting one of the nodes transmits all of the data packets, the second acknowledgment tone being transmitted by the transmitting node, the second acknowledgment tone being transmitted in response to the transmitting node receiving each of the expected first acknowledgment tones.

11. The method of claim 8 wherein each said second acknowledgment tone is transmitted to each other one of the nodes.

12. The method of claim 8 wherein the at least one second acknowledgment tone comprises a plurality of second acknowledgment tones, each said second acknowledgment tone being transmitted by a corresponding one of the nodes, each said second acknowledgment tone being transmitted in response to the corresponding node receiving each of the expected first acknowledgment tones.

13. The method of claim 8 wherein each data packet includes multiple copies of a set of data.

14. The method of claim 8 wherein the second acknowledgment tone comprises a negative acknowledgment tone, said negative acknowledgment tone being transmitted in response to less than all of the expected first acknowledgment tones being received.

15. A method for providing electronic communications between wireless nodes, the method comprising the steps of:
wirelessly transmitting data from a transmitting one of the nodes to a plurality of receiving ones of the nodes;
wirelessly transmitting a respective set of first acknowledgment tones from each of the receiving nodes to the transmitting node and to each other one of the receiving nodes, each said set of first acknowledgment tones being transmitted in response to the respective receiving node receiving the transmitted data; and
wirelessly transmitting at least one set of second acknowledgment tones from at least one of the nodes to each other one of the nodes, each said set of second acknowledgment tones being transmitted dependent upon whether a group of received said first acknowledgment tones matches a group of expected-to-be-received said first acknowledgment tones, each one of the sets of first acknowledgment tones and each one of the sets of second acknowledgment tones being transmitted in a corresponding sequence of frequency channels that is unique to the node transmitting the set of acknowledgment tones.

16. The method of claim 15 wherein the set of second acknowledgment tones is transmitted by the transmitting node, the second acknowledgment tones being transmitted in response to the transmitting node receiving each of the expected-to-be-received first acknowledgment tones.

17. The method of claim 15 wherein the at least one set of second acknowledgment tones comprises a plurality of sets of second acknowledgment tones, each said set of second acknowledgment tones being transmitted by a respective one of the receiving nodes, each said set of second acknowledgment tones being transmitted in response to the respective receiving node receiving each of the expected-to-be-received sets of first acknowledgment tones.

18. The method of claim 15 wherein the at least one set of second acknowledgment tones comprises at least one set of negative acknowledgment tones, each said set of negative acknowledgment tones being transmitted by a respective one of the receiving nodes, each said set of negative acknowledgment tones being transmitted in response to the first acknowledgment tones received by the respective receiving node not matching the expected-to-be-received first acknowledgment tones.

19. The method of claim 15 wherein the step of wirelessly transmitting data comprises wirelessly transmitting multiple copies of the data, each said set of first acknowledgment tones being transmitted in response to the respective receiving node receiving at least one of the copies of the transmitted data.

20. The method of claim 15 wherein each of the acknowledgment tones is transmitted in a corresponding frequency channel, the frequency channels being outside a frequency channel of the data.
